(19) United States
(12) Patent Application Publication
(10) Pub. No.: US 2003/0114166 A1
(43) Pub. Date: Jun. 19, 2003

(54) Method and device for load control of switching technology resources

(76) Inventors: Mathias Franz, Berlin (DE); Alfred Jugel, Geretsried (DE); Patrick Kleiner, Munchen (DE); Norbert Lobig, Darmstadt (DE); Klaus Pulverer, Munchen (DE)

Correspondence Address: Kevin R. Spivak, Morrison & Foerster LLP, Suite 5500, 2000 Pennsylvania Avenue, N.W., Washington, DC, 20006-1888, US

(21) Appl. No.: 10/229,281

(22) Filed: Aug. 28, 2002

(30) Foreign Application Priority Data
Aug. 29, 2001 (DE) 10142271.7

(51) Int. Cl. H04Q 7/20

(52) U.S. Cl. 455/453; 455/450; 455/452

(57) ABSTRACT

The present invention relates to a method for load control of an external switching technology resource for providing voice-channel related functions in a switching node whereby the resource is controlled by the switching node. The method according to the invention includes determining the capacity utilization of the resource, signaling the capacity utilization of the resource to the switching node, and regulating the number of available voice-channel related functions as a function of the capacity utilization of the resource. The invention also relates to a switching technology resource and a switching node for implementing the method.

### CLAIM FOR PRIORITY

This application claims priority to Application No. 10142271.7 which was filed in the German language on Aug. 29, 2001.

### TECHNICAL FIELD OF THE INVENTION

The present invention relates to a method for load control of an external switching technology resource for providing voice-channel related functions, as well as a switching technology resource and a switching node for implementing this method.

### BACKGROUND OF THE INVENTION

A switching node in a telecommunications network is generally made up of peripheral units (i.e., subscriber terminals or lines), a central computer platform, a call distribution device and other central devices.

The peripheral devices perform essential switching technology tasks tied in with the voice channels of the peripheral device. They therefore include switching technology programs, operating technology programs and administrative programs, as well as the data related to the device, such as connection position, signalization, authorizations, telephone numbers, individual characteristics of connecting lines and subscriber terminals, as well as expansion status and configuration of the peripheral device.

The central computer platform serves to coordinate control of establishing and terminating connections, as well as control of the reactions to administrative and error-related configuration changes. It is connected with the peripheral devices via the message distribution system, and these devices also communicate with one another in this way.

As shown in FIG. 1, in telephony via packet networks, signalization and voice are passed along in a disassociated manner, by separate paths. In other words, a strict differentiation is made between “call control” (i.e., signalization) and “routing” determining the path of the working data or voice). The peripheral devices then have the task of protocol processing and/or conversion, and the restrictions on the peripheral devices with regard to resource pool and number of terminable voice channels are eliminated.

Often, physical termination of the voice channels is handled by external switching technology resources, which from the point of view of the switching node are set up like the ports of a “classic” switching node. In other words, imaging of ports of the switching center takes place on voice channels of the external switching technology resource, as shown in FIG. 2, whereby the number of total available voice channels of the external resource corresponds to the number of ports. The number of ports assigned to the external resource in this connection depends on the physical performance; e.g., the memory capacity and the processor performance of the external resource.

If each voice-channel related function puts the same load on the external resource, then the number of assigned ports can be predetermined so that the resource is utilized to full capacity at maximum port use. This method becomes inefficient if different voice-channel-related functions put different loads on the resource, without this being evident from the call control and thereby calculable for the switching center.

FIG. 3 shows a switching center as an example. The switching center controls an external dialog machine (IVR, Interactive Voice Resource) in the packet network as an external switching technology device. If both dialogs with voice recognition and simple announcements without voice recognition are supported by the IVR system, the load per voice channel can vary greatly. To make this clearer, the following discussion will proceed from the example of an external interactive dialog machine, but the present invention in general relates to an external switching technology resource that provides voice-channel related functions.

The current total load of the dialog machine is known at the external switching technology resource, and any port-related outside control based on it is not possible with the present state of the art. Balancing (i.e., calculating the current capacity utilization of the switching technology resource) can not be carried out on the switching node, since this requires the introduction of special resource-dependent mechanisms and protocols. Therefore one must proceed from a “worst case scenario” when assigning ports to the IVR system, and therefore the capacity is definitely not utilized to its full extent in normal operation, as FIG. 4 clearly illustrates.

In the state of the art, announcements are provided in the TDM network while peripheral devices with hardware modules for providing announcements and DTMF (Discrete Tone Multi Frequency), or for voice recognition, are introduced into the switching center. To play a voice-channel related function such as an announcement or a dialog, the subscriber or trunk (connection to a remote switching center) is switched to a port of this special peripheral device for announcements and dialogs via a 64 kbit/s through-connection.

From a switching technology point of view, this involves switching through a connection from an A-side peripheral device via the coupling network to the B-side peripheral device with the announcement and dialog functionality. The B-side announcement and dialog port acts like a B-side trunk. The selection of the announcement and dialog function to be played is made by means of call control within the switching center to the peripheral device with the announcement and dialog functions, or it is predefined in a fixed manner.

An advantage of the invention is that the announcement and dialog functions are integrated into the switching center. Therefore, it is inexpensive to provide the announcement and dialog functions, and broad access to hardware functionalities of the peripheral devices can take place for announcement and dialog functionality.

However, the announcement and dialog functions cannot be used, or can only be used with a gateway ahead of them, if the working channel is routed in a packet-based manner and outside the switching center.

Furthermore, in this case, conversion of PCM/TDM data (Pulse Code Modulation/Time Division Multiplex) to data for packet network operation is required. Also, in this connection, the working data load for announcements and dialogs lies with the controlling switching center, resulting in a loss of voice quality through the conversion of the working or voice data.

In the state of the art, providing announcements and dialogs can, on the other hand, be carried out by means of external systems (external switching technology resources) in the packet network. At the same time, announcements and dialogs are provided either at the network transition between the packet network (e.g., Internet) and TDM network (conventional long-distance network) or by means of packet-based IVR systems designed specifically for this function. Here, control of the announcement and dialog function takes place by means of a call control server in the packet network that controls the connection.

One advantage of the invention is that these external switching technology resources can be used in packet networks without superfluous conversion of the working data being required. In addition, flexible usage possibilities exist, by means of linking with Internet services.

However, in this solution, the functions of the IVR system cannot be directly controlled and are not directly usable for a switching center that controls the connections passed along via the packet network.

The advantages of both solutions can be combined such that the packet-network-based resource, in other words the IVR system, is controlled directly by a TDM switching center for the purpose of call control, as shown in FIG. 3.

### SUMMARY OF THE INVENTION

The present invention, in one embodiment, discloses a method for load control of an external switching technology resource to provide voice-channel related functions, a switching technology resource and a switching node for implementing the method. This provides optimum capacity utilization of an external switching technology resource while simultaneously avoiding an overload of this resource.

According to one embodiment of the present invention, regulation of the number of available ports between the switching node and the external resource takes place as a function of the capacity utilization of the external resource. For this purpose, the physical capacity utilization is determined in the external resource, and if this value goes above and/or below a certain threshold value, which represents a measure of the capacity utilization of this resource, an appropriate call control is sent to the switching node by the resource. The switching node blocks or releases a corresponding number of ports, by means of which the voice-channel related functions become available.

According to another embodiment of the present invention, the assignment of the parts of the switching center to the external resource is controlled so that the number of available ports is automatically adapted to the current load of the external resource. Load control of the external switching technology resource takes place in this manner.

In this embodiment, communication between the switching center and the external resource takes place by means of transfer of maintenance information, namely startup or blocking of ports. Therefore a standardized communications protocol can be used, and a proprietary link between the switching center and the resource via specific interfaces is not required.

In addition, no complicated balancing with regard to capacity utilization of the external resource has to be performed by the switching center.

The capacity utilization of the switching technology resources is determined, for example, with regard to the current capacity utilization of a process capacity and a memory capacity of the resource.

In this embodiment, it is advantageous if the determination of capacity utilization takes place cyclically, according to predetermined time intervals.

If a threshold value is exceeded, ports are blocked by the switching center, whereby the number of blocked ports depends on the degree of capacity utilization.

In contrast to this, the switching center releases ports if the value drops below a threshold value. The number of released ports also depends on the degree of capacity utilization; the threshold values for blocking and releasing ports will generally have a different value.

### BRIEF DESCRIPTION OF THE DRAWINGS

The present invention will be explained in greater detail below, using preferred embodiment examples, and making reference to the attached figures, which show:

FIG. 1 a representation of the transmission paths of voice and call control.

FIG. 2 a representation of the port-related resource control.

FIG. 3 an example of an external announcement and dialog machine in a packet network.

FIG. 4 a representation of poor utilization of the capacities of

the announcement and dialog machine.

FIG. 5 a schematic representation of the external switching technology resource according to the invention, and of the switching node according to the invention.

FIG. 6 an example for load control of an external resource.

FIG. 7 a schematic representation of the capacity utilization of the external resource according to the present invention.

FIG. 8 shows an example for the use of the present invention in a telecommunications network.

FIG. 9 shows a schematic representation of the external resource 1 according to the invention and of the switching node 5 according to the invention.

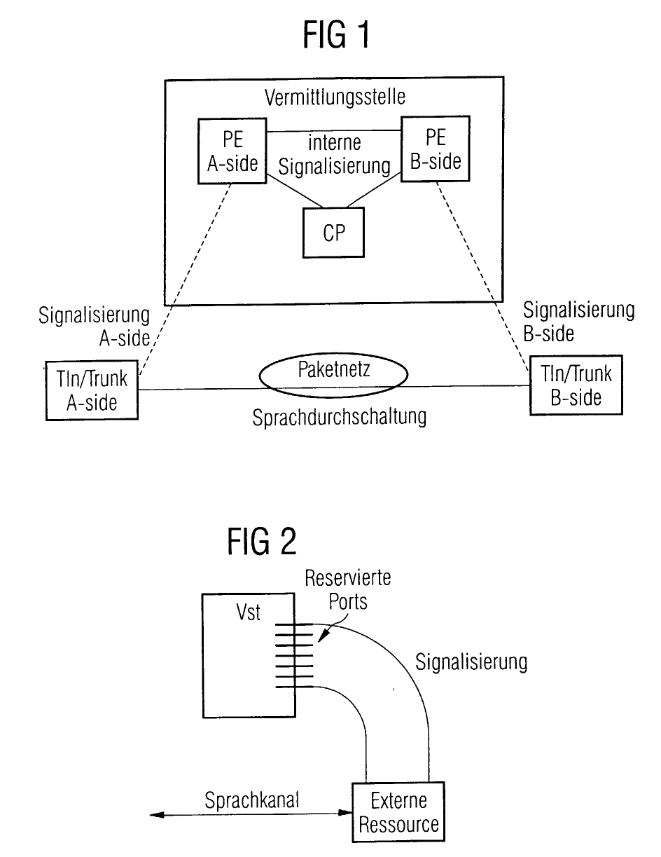

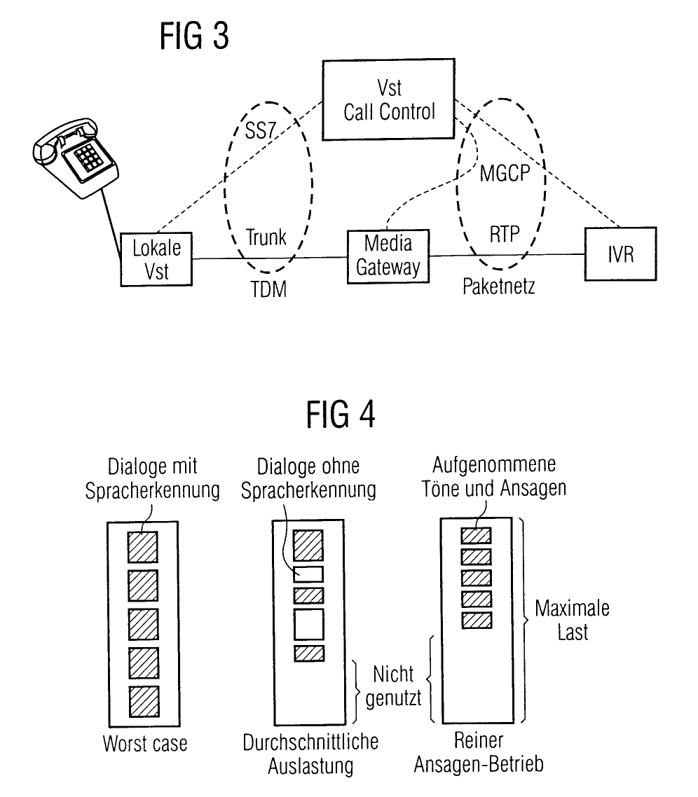

### DETAILED DESCRIPTION OF THE PREFERRED EMBODIMENTS

The external resource 1 includes a detection device 2 for determining the capacity utilization of the resource 1. This determination takes place according to specific criteria, such as current processor capacity utilization and/or memory capacity utilization, etc.

When the capacity utilization reaches an upper or lower threshold, which serves as a standard for the degree of capacity utilization, corresponding call control messages are sent to the switching node 5 by the call control device 3.

The switching node 5 according to the invention has a receiving device 6 for receiving the call control messages. Furthermore, the switching node 5 according to the invention has a regulation device 7 for regulating the number of available ports as a function of the capacity utilization of the resource 1.

In this embodiment, if a threshold value is exceeded, certain voice-channel related functions are blocked, and if the value drops below a certain threshold value, they are released. The two threshold values will generally have a different value.

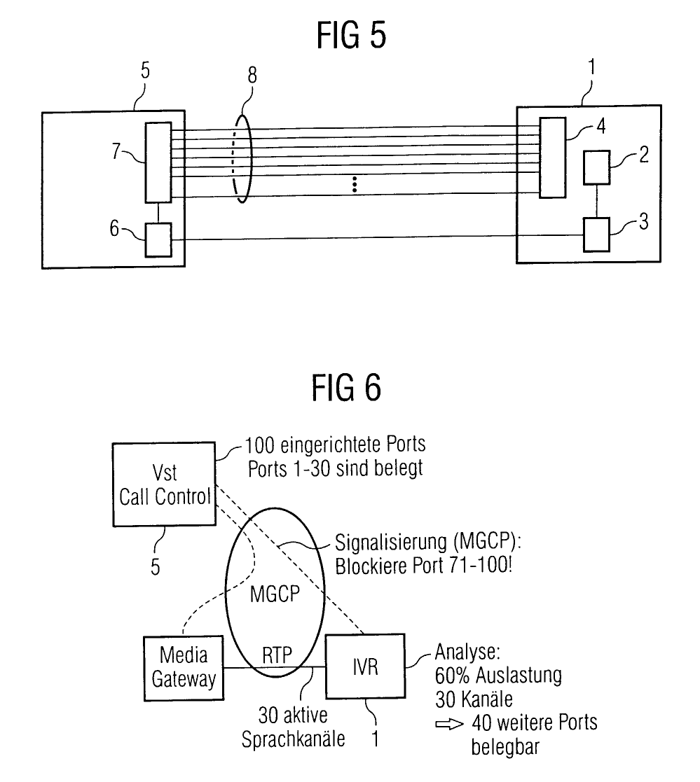

FIG. 6 shows an example for load control of an announcement and dialog machine (external switching technology resource 1). The reference numbers continue to refer to FIG. 5.

One embodiment according to the invention is based on load-dependent blocking and release of voice-channel-related functions of the switching node 5 by means of port-specific call control between the control server located in the switching node 5 and the external switching technology resource (e.g., IVR server).

The expected number of voice channels that the external resource can serve at low or average capacity utilization per channel serves as a basis. In contrast to the state of the art, a correspondingly high number of voice-channel related functions is made available for the resource on the switching center.

The external resource 1 now cyclically checks the current load (between 0% and 100%) in the current operation, and compares it with the current number of voice channels being served. If the resulting measurement value exceeds a critical value, then the resource 1 prompts the switching center 5 to block a certain number of still-unused voice-channel related functions. A simple example of such a measurement value is

$$λ = \frac{ports still available}{ports not yet busy} = \frac{unblocked ports - busy voice channels}{( 1 - capacity utilization ) * established ports}$$

where “ports still available” is the number of ports that are currently neither blocked nor busy, and “ports not yet busy” is the number of ports that can foreseeably still be used to utilize the external switching technology resource to its full capacity. Furthermore, “unblocked ports” is the number of non-blocked (i.e., available and already busy) ports, the “busy voice channels” is the number,of voice channels that are currently busy (i.e. the number of voice channels via which the functions of the external resource are currently being called up), and “established ports” is the number of maximum ports.

The formula assumes that in the case of average utilization, if all established ports were busy, this would produce exactly a 100% load. The remaining residual load (in other words, 1-load) would therefore probably be completely exhausted by a corresponding percentage of the total number of established ports.

In the same way, if the value drops below a lower limit, the release of blocked ports is requested.

Standardized call control protocols, such as MGCP (Media Gateway Control Protocol), which serve for communication between the switching center (switching node according to the invention) and the external resource, support the transfer of so-called maintenance data, since in the state of the art the control intelligence lies with the switching center. This also includes blocking and release of ports in the case of malfunction of the external resource. If one interprets overly high or overly low values of the above measurement value k as a maintenance case, the call control protocol can be used in a standard manner to prompt blocking or release of the desired number of ports by the switching center.

In FIG. 6, the external resource 1 measures a current load of 60%, brought about by 30 busy ports; i.e., brought about by 30 active voice channels. In this example, the voice channels are transmitted via RTP (Real Time Protocol) by way of a packet data network, using a so-called media gateway. The media gateway has the task of providing the network transition between a packet network and a voice network, generally the public telephone network.

If on average 40% of the resource still available were to become busy, 40% of 100 established ports, in other words another 40 channels, could be switched in (indeed, for the original 100 established ports, an average load per channel was assumed). This means that together with the 30 voice channels already active, a maximum of 70 of the 100 established ports can be utilized at this time. Ports 71 to 100 are therefore temporarily blocked by the switching center.

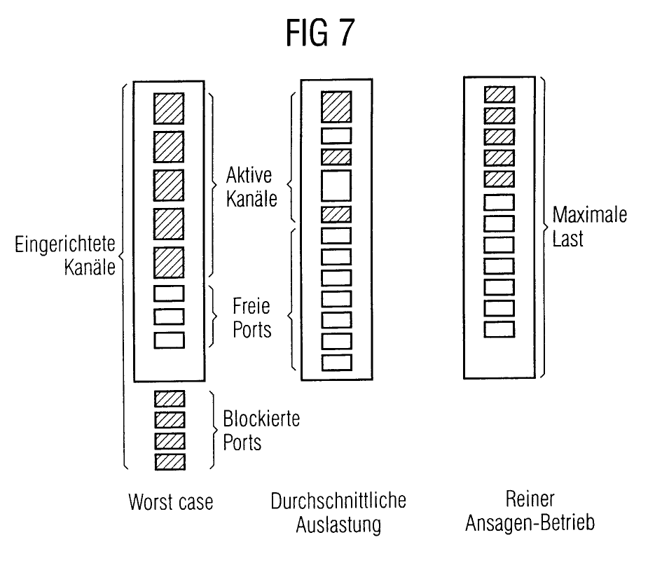

As FIG. 7 shows, a variable number of ports are provided to the external resource, which can be adapted to the current capacity utilization of the resource without using special interfaces or protocols. In this embodiment, the switching center does not need to receive and balance any information about the content of the established voice channels. External resources can be dimensioned much more efficiently by means of the method described; i.e., there is no “worst case” dimensioning as would be necessary using a conventional method.

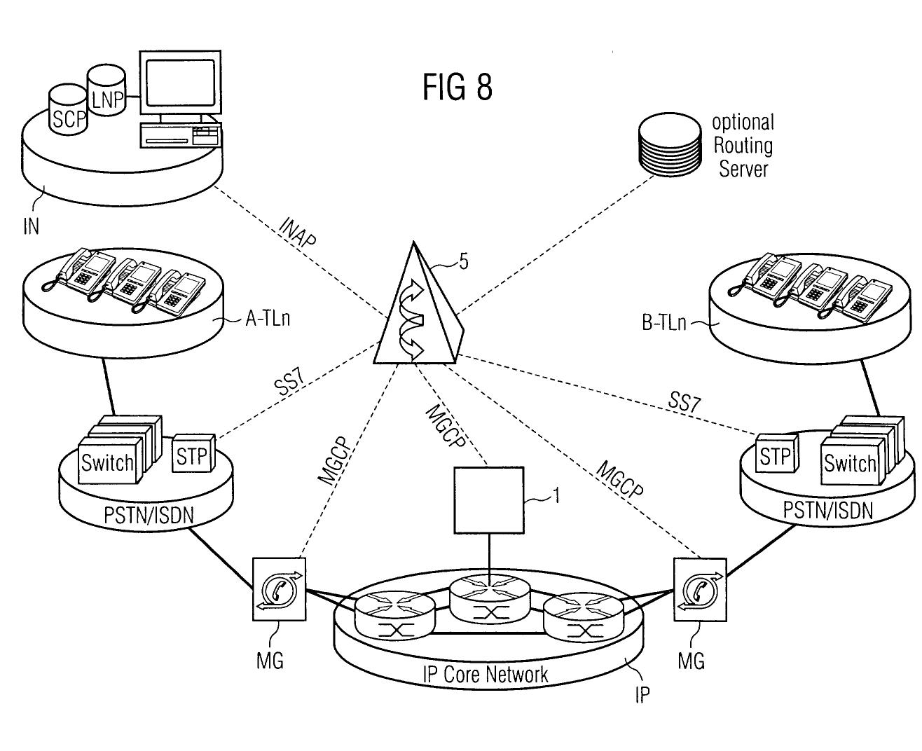

FIG. 8 shows an example for the use of the present invention in a telecommunications network. Here, the central control is carried out by a switching node 5, which is a call control node in this example. This switching node transmits call control messages, for example to the intelligent network IN via INAP (Intelligent Network Application Part), to public telephone networks (ISDN, PSTN), for example to create a connection between an A subscriber (A-Tln) and a B subscriber (B-Tln), to servers for routing data (optional routing server), etc.

Furthermore, the switching node 1 controls external switching technology resources 1, network transition nodes (media gateways, MG), etc. The media gateways form the interface between a packet network (e.g., an IP network) and the public telephone network.

In this embodiment, call control takes place by means of different protocols, such as the signaling system No. 7 (SS7) and the Media Gateway Control Protocol (MGCP or H.248). For subscriber call control, the protocol H.323, for example, can be used for packet data transmission.

IP-based IVR resources available outside of the switching node 5 are modeled as virtual announcement ports at a new-type media gateway. This involves an external, universally usable IVR system whose task is providing IVR functionality. These IVR resources are controlled by the switching node 5, using MGCP/H.248.

If an announcement and dialog function is supposed to be used in an external IVR, an announcement/dialog port becomes busy on the B side. The type of IVR function is then reported to the external IVR system (Interactive Voice Response, external switching technology resource 1) by additional MGVP/H.248 call control.

With regard to low effort and expense for modifications, and optimized hardware costs of the switching node 5, control of the virtual announcement/dialog ports takes place on the basis of virtual LTGs (Line Trunk Groups) with announcement and dialog function. In this way, the internal interface of the switching node between the functions requesting the IVR function (in other peripheral devices or in the central processor), in particular, remains unchanged, which significantly reduces the development effort and expense.

In this embodiment, the peripheral device for controlling the IVT function, which is now virtual, essentially has the function of passing on IVT order data and passing along feedback from the IVT system. The control of the IVR-specific hardware modules of the peripheral device with IVR function at a comparatively low logic level, which exists in conventional usage, is eliminated.

The IVR system 1 acts as a media gateway with regard to control by the switching node 5. Partial or total failures of the external resource 1 are imaged via MGCP (or H.248) as temporary non-availability of virtual announcement and dialog ports (i.e., blocking of ports), which then can no longer be used by the switching node 5. It is this failure control that can now be used to make the method for load control, according to the invention, usable.

The concrete algorithm corresponds to the procedure described in FIG. 6. The external switching technology resource 1 knows the number of free virtual ports currently available in the switching node 5. From the currently measured load and the number of busy voice channels, it calculates (for example) a measurement value, according to the formula described above, at regular intervals, which describes the capacity utilization of the available ports. This formula is not optimal; a better but more complex formula would give a stronger weighting to high capacity utilization values.

If this measurement value exceeds a critical value (e.g., λ=1.5), then the detection device of the external switching technology resource calculates how many additional voice channels it could still serve at an average load, and requests that the excess channels be blocked. In the example of FIG. 6, 60% capacity utilization is measured for 30 out of 100 busy ports. In other words, 0.4*100=40 ports that can still be used, as opposed to 70 available ports. This corresponds to λ=1.75 and thereby exceeds the threshold value. Therefore, ports are blocked. Since another 40 channels can still be served, on average, at an additional load capacity of 40%, this yields a total of 70 channels that the external resource can currently terminate without an overload.

Therefore, 30 ports that are supposed to be temporarily unavailable are reported to the switching node 5 via MGCP.

What is claimed is:

1. A method for load control of an external switching technology resource for providing voice-channel related functions in a switching node, where the resource is controlled by the switching node, comprising:
determining a capacity utilization of the resource;
signaling the capacity utilization of the resource to the switching node when a value representative of the capacity utilization is above and/or below a predetermined threshold value; and
regulating a number of available voice-channel related functions as a function of the capacity utilization of the resource by the switching node.

2. The method according to claim 1, wherein the capacity utilization of the resource is determined based on a current capacity utilization of a processor capacity and a memory capacity of the resource.

3. The method according to claim 1, wherein the determination of the capacity utilization takes place cyclically, according to predetermined time intervals.

4. The method according to claim 1, wherein voice-channel related functions are blocked if a threshold value is exceeded, wherein the number of blocked voice-channel related functions depends on a degree of capacity utilization.

5. The method according to claim 1, wherein voice-channel related functions are released if the capacity utilization value drops below a threshold value, wherein a number of released voice-channel related functions depends on a degree of capacity utilization.

6. The method according to claim 5, wherein the voice-channel-related functions are provided via at least one port.

7. A switching technology resource for implementing load control of an external switching technology resource for providing voice-channel related functions in a switching node, where the resource is controlled by the switching node, comprising:
a detection device to determine a capacity utilization of the resource; and
a signaling device to signal from the resource to the switching node the capacity utilization of the resource if a value representative of the capacity utilization is above and/or below a predetermined threshold value.

8. A Switching node for implementing load control of an external switching technology resource for providing voice-channel related functions, comprising:
a receiving device to receive signaling messages that include information about capacity utilization of a switching technology resource; and
a regulation device to regulate a number of available voice-channel related functions as a function of the capacity utilization of the resource.

9. The switching node according to claim 8, wherein the voice-channel related functions are provided via at least one port.
